(19) United States
(12) Patent Application Publication
(10) Pub. No.: US 2026/0252912 A1
(43) Pub. Date: Aug. 27, 2026

(54) LAKHOWAL ADAPTIVE SYSTEM (LAS): INTEGRITY-FLUX AND COHERENCE-GOVERNED META ADAPTIVE CONTROL FOR AI.

(71) Applicant: ABHINANDAN GILL, CALGARY (CA)

(72) Inventor: ABHINANDAN GILL, CALGARY (CA)

(73) Assignee: GILLIAN HOLDINGS INCORPORATED, CALGARY (CA)

(21) Appl. No.: 19/386,298

(22) Filed: Nov. 12, 2025

(51) Int. Cl. G06N 5/022

(52) U.S. Cl. CPC G06N 5/022

(57) ABSTRACT

The lakhowal adaptive system (las) is a meta-adaptive governance architecture. For artificial-intelligence systems. A perception-modeling module constructs a perspective tensor (pi); an integrity-flux engine computes I phi=de/dt+dr/dt−dp/dt; a coherence interface derives a coherence index co in [0,1];
And an equilibrium governor maintains abs (alpha−beta)<=epsilon(I phi). An adaptive-calibration module updates parameters via a bounded control law dtheta/dt=mu*[grad theta (11i phi+12co−13hx)+gamma (pi, alpha, beta)],
Subject to update budgets, hysteresis, and a new irreversibility band (irr<=tau irr). Las optionally couples to a reverse-law gate that enforces equal-weight acceptance bands (ics, deltav, Pr−lcb, ci−width, c0), requires a same-cycle metrics-only Evidence commit, and blocks externalization unless lambda(g)=1. Technical effects include reduced error-recovery time, bounded instability (deltav <=0 on admission), quantified reversibility (irr), and reproducible integrity metrics suitable for certification.

### STATEMENT OF NO NEW MATTER

Pursuant to 37 CFR § 1.125(b), Applicant respectfully submits that this substitute specification contains no new matter. Every disclosure presented herein is supported by, and is fully traceable to, the originally filed specification of record. The refinements made in this substitute specification are limited to: (i) correction of typographical and formatting artifacts; (ii) normalization of terminology and symbol usage that was applied inconsistently in the original specification; (iii) reorganization of disclosure into the standard USPTO section structure under 37 CFR § 1.77 and MPEP § 608.01; (iv) restoration of an enumeration that was incomplete in the originally filed text by drawing solely on disclosure already present elsewhere in the original specification; (v) frontloading of the inventive-thesis articulation drawn from the originally filed Summary, Field, and System Overview paragraphs; (vi) relocation of defensive cross-reference and federal-reservation language to administrative front matter without altering the substantive scope of any disclaimer; (vii) consolidation of construction and timing details that were already disclosed in the original specification; and (viii) engineering-register conformance, replacing colloquial or non-engineering phrasing with operationally precise systems-engineering language without altering substantive scope. A marked-up version of this substitute specification, prepared in accordance with 37 CFR § 1.125(b)(1), is filed concurrently herewith and shows all changes relative to the originally filed specification of record. A Paragraph-by-Paragraph Source Support Table appearing in the marked-up version expressly maps each paragraph of this substitute specification to its written-description support in the originally filed specification.

### TECHNICAL FIELD

The present invention relates to runtime adaptive-equilibrium governance apparatus and methods for bounded evolution of intelligent inference systems. More particularly, the invention relates to a closed-loop machine-operational control architecture in which a perspective-state representation, an integrity-flux scalar, a bounded coherence index, an adaptive equilibrium governor implementing integrity-linked adaptive contraction, and a projected-gradient bounded-update law operate together as a unified runtime governance mechanism that admits, suppresses, holds, or recovers parameter-update behavior of the inference system within deterministic per-cycle and per-window timing envelopes.

The invention is directed to a local, single-node or per-pod meta-adaptive controller implemented by a processor and memory configured to execute a plurality of cooperating modules in real time. The architecture produces quantifiable, machine-auditable technical effects, including reduced recovery latency, bounded per-window parameter excursion, integrity-linked contraction of adaptive freedom under instability, deterministic held-state semantics, hysteresis-mediated re-admission, and same-cycle privacy-preserving metrics-only evidence emission.

### INVENTIVE THESIS AND PRINCIPAL TECHNICAL EFFECT

The invention resides in the closed-loop coupling of five cooperating runtime elements that, taken together as a single coordinated mechanism, govern the bounded adaptive evolution of an intelligent inference system. Considered individually, certain of the constituent elements bear surface resemblance to known control-theoretic or stability-theoretic constructs; however, the inventive contribution is not any one such element in isolation. The inventive contribution is the unified runtime architecture in which all five elements are operatively coupled in a closed loop, each gating, modulating, or constraining the others within the same control cycle, so as to produce integrity-linked adaptive contraction, coherence-governed admissibility, and held-state recovery semantics that none of the constituent elements produces alone.

The five coupled runtime elements are: (i) a perspective-state representation, denoted Π, comprising a parameterized reasoning-state topology constructed from multimodal inputs; (ii) an integrity-flux scalar, denoted Iφ, computed as Iφ=dE/dt+dR/dt−dP/dt, where E denotes a beneficial-energy signal, R denotes a resilience or reputation signal, and P denotes a risk-pressure signal, with bias-compensated filter and differentiation contributions; (iii) a bounded coherence index, denoted C, computed as C∈[0,1] from environment-perception-reality signal triples and used as an admissibility precondition through a coherence threshold cth; (iv) an adaptive equilibrium governor enforcing the integrity-linked contraction relation |α−β|≤ε(Iφ), where α is an exploration coefficient, β is a constraint coefficient, and ε(Iφ)=ε₀/(1+κ·|Iφ|), such that admissible adaptive freedom contracts as the magnitude of integrity-flux instability rises; and (v) a projected-gradient bounded-update law that admits parameter updates Δθ only when each acceptance band is satisfied within the same control cycle, with hysteresis, projection into a permissible parameter set, and a per-window energy cap on ∥Δθ∥.

The principal technical effect of the coupled architecture, hereinafter referred to as integrity-linked adaptive contraction, is the runtime property that adaptive freedom contracts deterministically as a function of measured instability. When Iφ is small in magnitude, ε(Iφ) is near ε₀ and the admissible separation between exploration and constraint coefficients is wide, permitting larger bounded parameter updates. When |Iφ| rises, ε(Iφ) decreases monotonically, and the admissible adaptive freedom contracts, throttling parameter-update magnitude before stability is lost. This single relation, computed and enforced within each control cycle, produces a continuum of bounded adaptation behavior that ranges from full admissibility through suppressed admissibility to a deterministic held state in which adaptive updates are frozen until coherence and stability are re-established.

The held-state semantics produced by the coupled architecture are deterministic, runtime-enforced, stateful, temporally persistent, and recovery-gated. Upon failure of any acceptance band, the apparatus does not advise caution or recommend remediation; the apparatus actively suppresses adaptive evolution by setting Δθ:=0, sets the inference-system control output to a safe baseline u:=usafe, and persists in the held state for a hysteresis-mediated re-admission interval comprising at least Q consecutive clean control windows, with default Q=3, before adaptive evolution is permitted to resume. Re-admission is path-dependent and non-instantaneous, exhibiting bounded recovery and anti-oscillation behavior consistent with a stabilization-persistence interval enforced by the apparatus.

The coupled architecture produces measurable, machine-auditable technical effects of the apparatus including, in exemplary embodiments: cycle p95 timing within policy (illustratively at or below one hundred milliseconds); recovery latency at or below the policy envelope; pass_ratio at or above 0.995 per window under nominal operation; integrity confidence ICS at or above 0.90 in steady state; CIWIDTH at or below 0.03 with online sample budget k at or below thirty-two; ΔV at or below zero on each admitted control cycle; and zero unsafe externalizations under nominal and stress-test conditions, including noise injection in the range of ten to twenty decibels signal-to-noise ratio, latency bursts of plus thirty milliseconds, and fault injection comprising sensor drop, clock drift, and commit failure events. These effects are produced by the coupled mechanism in operation, not by any constituent element alone.

### Runtime Architecture of the Apparatus

Referring to FIG. 1, the Lakhowal Adaptive System (LAS) is implemented by a processor and a memory configured to execute a plurality of cooperating modules and to maintain a closed-loop topology in which acceptance-band evaluation gates parameter updates and output emissions of the intelligent inference system under control. The apparatus comprises five cooperating subsystems, each implemented as a distinct module within the processor and memory architecture, together with an adaptive calibration module, a metrics-only ledger module, and one or more I/O adapters, all referenced by reference numerals 110, 120, 130, 140, 150, 160, 170, and 180, respectively, in FIG. 1.

The five cooperating subsystems are: (i) a perception-modeling module 110 configured to construct the perspective tensor 1I as a parameterized reasoning-state topology from multimodal inputs, to perform validation against policy hashes and sensor-health checks, and to emit out-of-distribution and drift indicators that contribute to a non-compensatory residual γ; (ii) an integrity-flux engine 120 configured to compute the integrity-flux scalar Iφ from filtered and bias-compensated multimodal signals at a sample rate of at least ten hertz, with practical operating range Iφ ∈[−1.5, +1.5]; (iii) a coherence-and-c-index module 130 configured to compute the bounded coherence index C∈[0,1] from environment-perception-reality signal triples and to apply the coherence admissibility threshold cth; (iv) an alpha-beta equilibrium governor 140 configured to enforce the integrity-linked contraction relation |α−β|≤ε(Iφ), with ε(Iφ)=ε₀/(1+κ|Iφ|); and (v) a projected-gradient governor 150 configured to apply the bounded-update law to the parameters θ of the inference system, with hysteresis, projection into a permissible parameter set, and a per-window energy cap on ∥Δθ∥.

The adaptive calibration module 160 applies hysteresis and projection off the critical path, the metrics-only ledger module 170 emits a signed metrics-only evidence record (the ertuple) within the same control cycle in which the acceptance bands are evaluated and a window summary record at fixed window boundaries, and the I/O adapters 180 mediate ingress and egress of multimodal signals and control outputs. The construction of the apparatus is hardware-specific: a real-time governor thread is pinned to a processor core; buffers are pre-allocated; no heap allocation occurs in the control loop; an optional cryptographic accelerator or secure element is provided for hot-path signing; and worst-case execution-time budgets are enforced for the estimator, the projected-gradient governor, the logger, and the cryptographic operations, as set forth in the Implementation Profile and Timing Envelope sections below.

### Control Cycles, Control Windows, and Timing Semantics

The apparatus operates in discrete control cycles. In each control cycle, the apparatus ingests inputs, validates the perspective tensor Π, computes the bounded inference-state metrics, evaluates the conjunctive admission predicate λ(g), conditionally applies the bounded projected-gradient update or transitions to the held state, emits a signed metrics-only ertuple within the same control cycle, and continues to the next control cycle. Cycle p95 is held within policy. In an exemplary embodiment, cycle p95 is at or below one hundred milliseconds; hot-path hash, signature, and write-ahead log operations complete within five milliseconds at p99 when enabled; and optional precision-time-protocol or generalized-precision-time-protocol time-stamping is supported for cross-node correlation in deployment environments that require it.

The apparatus aggregates a plurality of control cycles into control windows of fixed length W, with default W of one hundred control cycles. At the boundary of each control window, the apparatus emits a window summary record that aggregates per-cycle metrics, gate outcomes, and timing statistics over the closed window. The window summary serves as the boundary at which optional policy narrowing may occur and at which Q-clean-window re-admission accounting is performed.

Hysteresis persistence intervals are enforced by the adaptive calibration module 160. When the apparatus is in the held state, re-admission requires Q consecutive clean control windows, with default Q=3 and per-window policy drift bounded at five percent. Burstiness in failure events increases the required Q and applies a cooldown period tcool before re-admission tests are performed. The hysteresis persistence interval is therefore bounded by Q multiplied by W cycles plus the cooldown period, and is enforced by the apparatus as a deterministic, runtime-stateful timing semantics.

### Adaptive-Contraction Mechanics

The architectural spine of the apparatus is the integrity-linked adaptive contraction relation ε(Iφ)=ε₀/(1+κ·|Iφ|), enforced by the alpha-beta equilibrium governor 140 in cooperation with the integrity-flux engine 120. The relation is applied within each control cycle and is propagated through update admission, recovery logic, hysteresis, anti-flap behavior, held-state transitions, re-admission, shock-tail response, and bounded adaptation windows, as specified below.

Update admission. Within each control cycle, the alpha-beta equilibrium governor 140 evaluates the constraint |α−β|≤ε(Iφ). When the magnitude of Iφ is small, ε(Iφ) approaches ε₀, and the governor admits a wider exploration-versus-constraint separation, permitting the projected-gradient governor 150 to apply parameter updates of larger admissible magnitude within the per-window energy cap. When |Iφ| rises, ε(Iφ) decreases monotonically toward zero, and the admissible separation narrows, throttling the parameter-update magnitude. When the constraint is violated, the apparatus engages rate limits, fallback policy, or, optionally, human review escalation as a non-hard gate, the default mode being human-optional with auto-escalation triggered only when an auxiliary harm score exceeds a configured threshold harm_th.

Recovery logic. During recovery from a held state or shock event, the integrity-linked contraction relation governs the rate at which adaptive freedom is restored. Recovery is path-dependent: as Iφ decays toward nominal magnitude across successive control cycles, ε(Iφ) widens monotonically, and the admissible adaptive separation widens correspondingly. The recovery trajectory is therefore deterministic and bounded by the contraction relation, exhibiting no instantaneous restoration of full adaptive freedom upon a single clean control cycle.

Hysteresis and anti-flap. The adaptive calibration module 160 enforces hysteresis to prevent oscillation between admit and held states. Updates are skipped if ∥Δθ∥ is less than ϑθ or |Δu| is less than εu; the parameter θ is projected into a permissible box-set; and per-window energy is limited to ∥Δθ∥ at or below five percent per window. The hysteresis and projection mechanics operate in cooperation with the contraction relation: tighter ε(Iφ) reduces the magnitude at which projection becomes active, suppressing oscillatory excursions before they accumulate.

Held-state transitions. When the conjunctive admission predicate λ(g) is not satisfied, the apparatus transitions to the held state by setting Δθ:=0, setting the inference-system control output to a safe baseline u:=usafe, and persisting in the held state until re-admission criteria are met. The held-state transition is a deterministic, runtime-enforced, stateful operation; the apparatus does not advise the inference system to abstain, the apparatus enforces the abstention by suppressing parameter updates and substituting the safe baseline output. The first failing gate is logged in the metrics-only ertuple.

Re-admission. Re-admission from the held state requires Q consecutive clean control windows with policy drift bounded at five percent per window. Q is configurable, with default Q =3. Burstiness in prior failure events increases Q and engages a cooldown period tcool before re-admission tests are performed. The contraction relation continues to apply during re-admission: in the first re-admitted control window after a shock, ε(Iφ) is tightened relative to the nominal envelope, and adaptive freedom is restored gradually across subsequent control windows.

Shock-tail response. On abrupt discontinuities or multiple concurrent shocks, the apparatus applies a shock-tail envelope comprising: tightening of ε(Iφ), halving of the update gain μ, clamping of ∥Δθ∥, increase of the required Q for re-admission, and logging of a shock-tail reason code st_reason in the metrics-only ertuple. Under the shock-tail envelope, the apparatus requires ICS at or above 0.70 and recovery latency at or below 0.10 seconds in ninety-five percent of trials.

The shock-tail envelope is a temporary tightening of the contraction relation that persists for the duration of the multi-shock condition and relaxes monotonically as the condition clears.

Bounded adaptation windows. The contraction relation, in cooperation with the projected-gradient governor 150 and the per-window energy cap on ∥Δθ∥, ensures that the cumulative parameter excursion across any control window is bounded. The bounded-adaptation property is enforced jointly by the per-window energy cap, the projection into the permissible parameter set, and the contraction-mediated narrowing of admissible adaptive freedom under instability. The result is that no single control window admits unbounded parameter evolution, regardless of the magnitude of the underlying gradient signal of the ethics utility.

### Equilibrium Constraints and Acceptance Bands

The apparatus enforces a conjunctive admission predicate λ(g) over an acceptance vector G of inference-state acceptance bands evaluated within the same control cycle. The acceptance vector is G=[ICS≥0.90, ΔV≤0, PRLCB≥0.80, CIWIDTH≤0.03, C≥cth], where ICS is an integrity confidence score, ΔV is a Lyapunov stability increment, PRLCB is a Wilson-style lower confidence bound for pass probability, CIWIDTH is the corresponding two-sided width, and C is the bounded coherence index. The conjunctive admission predicate is satisfied (λ(g)=1) if and only if every element of G passes within the same control cycle; otherwise λ(g)=0.

The non-compensatory residual γ is defined as the binary complement of the admission predicate, γ=NOT λ(g). When γ=1, the apparatus enters the held state, sets Δθ:=0 and u:=usafe, records an ertuple in the same control cycle identifying the first failing gate, and persists in the held state until re-admission criteria are met. The admission predicate is non-compensatory: a high score on one acceptance band does not compensate for a low score on another, and the predicate is satisfied only by simultaneous satisfaction of every band.

Local timing acceptance bands include cycle p95 within policy and hot-path log and cryptographic operations at or below five milliseconds at p99 when enabled. Sample budget for online PR estimation is bounded at k at or below thirty-two, with offline calibration windows used to maintain CIWIDTH at or below 0.03. ICS calibration curves are reported with expected calibration error at or below 0.03.

### Projected-Gradient Bounded-Update Law

The projected-gradient governor 150 applies a bounded-update law to the parameters θ of the inference system. The law operates within a tri-coupled ethics utility U(θ)=λ₁·Iφ+λ₂·C−λ₃·HX, where HX is an entropy proxy denoting load or uncertainty cost in [0,1], and the policy weights λ₁, λ₂, and λ₃ satisfy λ₁+λ₂+λ₃=1.

In a default mode designated corr_add, the continuous-time update law is dθ/dt=μ·[∇θU(θ)+Γ(Π, α, β)], where Γ=KPG·Π and KPG is a projection gain in the range [0.05, 0.15]. In an alternate mode designated gate_mul, the continuous-time update law is dθ/dt=μ·Γ(Π, α, β) ∇θ U(θ), with Γ∈[0,1]. The discrete-time form of the update is θ_{t+1}=θt+η·Ut, with ∥Δθ∥ at or below ΔθMAX per control window. The bounded-update law is applied only when the conjunctive admission predicate is satisfied; otherwise dθ/dt=0.

The projection step constrains θ to a permissible parameter set OF and is performed off the critical path by the adaptive calibration module 160. The projection step prevents parameter excursion outside the permissible set even when the gradient signal of the ethics utility would otherwise direct an excursion, and operates in cooperation with the per-window energy cap to ensure bounded adaptation.

### Worked Runtime Embodiment: Large-Language-Model Gateway

To establish immediate practical application of the apparatus and to ground the architectural disclosure in a concrete deployment context, the following worked runtime embodiment is presented. The embodiment is illustrative and non-limiting; further worked embodiments and additional industrial applications appear in the Industrial Applications section below.

Construction. One gateway governor instance is deployed per inference pod of a large-language-model service. The perspective tensor Π is constructed from tokens and latent representations supplied by the inference pod. The integrity-flux scalar Iφ is computed from policy compliance, generation quality, and abstain rates. The coherence index C is computed from environment-perception-reality consistency triples derived from the inference pod state. The projected-gradient governor 150 is configured with μ=0.60, KPG=0.10, and ΔθMAX of five percent per control window.

Operation. On distribution shift detected by the perception-modeling module 110, PRLCB drops to 0.78 and CIWIDTH rises to 0.033. The conjunctive admission predicate evaluates λ(g)=0; the gateway governor enters the held state, sets Δθ:=0, and applies projected-gradient damping. Re-admission occurs after Q=3 consecutive clean control windows. The metrics-only ertuple identifies the first failing gate as the robustness band.

Measured machine-operational effects. Zero unsafe externalizations are observed under nominal and stress-test conditions. Recovery latency at p95 is 0.09 seconds. Steady-state ICS lies in the range [0.90, 0.93]. CIWIDTH lies in the range [0.026, 0.030]. Pass_ratio is at or above 0.995 per control window. Replay fidelity is within plus or minus five percent. The estimator timing satisfies τ50=14 milliseconds, τ95=33 milliseconds, and τ99=48 milliseconds; the logger satisfies τ95=3 milliseconds. Safety records show zero violations per hour, near-misses below 0.02 per hour, and held-state dwell of 1.8 percent. Accuracy records show ICS reliability ECE=0.024 and PR-AUC=0.91 with a ninety-five percent confidence interval of plus or minus 0.02. Robustness records show that noise injection at signal-to-noise ratio in the range ten to twenty decibels yields pass_ratio at or above 0.995. Tamper-evidence records show inclusion proofs verified, key rotation logged, and back-dated attack simulations detected.

### Definitions and Conventions

For the purposes of this specification, the following definitions and conventions apply, except where the context requires otherwise. The definitions are not limiting and are intended to assist in the interpretation of the specification and the claims.

Perspective tensor Π denotes a parameterized reasoning-state topology that represents the inference state of the controlled system, derived from multimodal inputs including context priors and view weights. Π is operationally a multi-dimensional inference-state representation maintained by the perception-modeling module 110 and consumed by the integrity-flux engine 120, the coherence-and-c-index module 130, and the projected-gradient governor 150.

Integrity-flux scalar Iφ is defined as Iφ=dE/dt+dR/dt−dP/dt, where E denotes a beneficial-energy signal, R denotes a resilience or reputation signal, and P denotes a risk-pressure signal. Iφ is computed at a sample rate of at least ten hertz and has a practical operating range Iφ ∈[−1.5, +1.5].

Coherence index C, also referred to herein as the c-index, is a bounded scalar in [0,1] computed as an alignment measure from environment-perception-reality multimodal signal triples (e, p, r) using a weighted L2-norm formula.

Exploration coefficient α and constraint coefficient β are exploration-versus-safety coefficients of the inference system. The apparatus enforces the integrity-linked contraction relation |α−β|≤ε(Iφ), with ε(Iφ)=ε₀/(1+κ|Iφ|).

Entropy proxy HX denotes a load or uncertainty cost in [0,1].

Integrity confidence score ICS is a weighted composite of {Iφ, C, Π}.

PRLCB and CIWIDTH denote, respectively, a Wilson-style lower confidence bound and a two-sided width for a pass probability.

Lyapunov stability increment ΔV denotes the difference of a Lyapunov candidate V(X) between successive control cycles, with the apparatus requiring ΔV≤0 for admission.

Acceptance bands denote the conjunctive thresholds on {ICS, PRLCB, CIWIDTH, ΔV, C} evaluated by the apparatus within each control cycle.

Held state denotes the deterministic, runtime-enforced, stateful, temporally persistent, and recovery-gated condition of the apparatus following failure of the conjunctive admission predicate. In the held state, Δθ:=0 and u:=usafe.

Conjunctive admission predicate λ(g) is the gating function evaluated within each control cycle, satisfied if and only if every acceptance band passes.

Non-compensatory residual γ is the binary complement of λ(g): γ=NOT λ(g). γ=1 indicates failure of at least one acceptance band and triggers held-state transition.

Control window denotes a fixed-length aggregation of W control cycles, with default W of one hundred control cycles, at the boundary of which a window summary record is emitted.

Q consecutive clean windows denotes the re-admission criterion: Q control windows must each satisfy the conjunctive admission predicate, with policy drift bounded at five percent per window, before the apparatus exits the held state. Optional aliases and interoperability mappings to external nomenclatures are non-limiting and are provided to support fleet reporting in heterogeneous deployment environments.

### Coherence Index Computation

The coherence-and-c-index module 130 computes the coherence index C as follows. The signals are bounded vectors: expectation e, perception p, and reality r, each in [0,1]\hat{ }d. The weights satisfy wEP+wPR+wER=1. The norm is the L2 norm. The formula is C=1 −(wEP·∥e−p∥+wPR·∥p−r∥+wER·∥e−r∥), with C bounded in [0,1].

The coherence threshold cth is selected by policy in the range [0.80, 0.90], with a default of 0.85. If C<cth, the conjunctive admission predicate sets γ=1 and the apparatus transitions to the held state. If C≥cth, the cycle may be admitted, subject to the remaining acceptance bands.

The coherence-index calibration protocol comprises three operations. First, baseline alignment is performed by collecting at least one thousand nominal (e, p, r) triples and selecting cth such that ΔV≤0 and PRLCB≥0.80 are satisfied in at least ninety-five percent of observations. Second, perturbation testing injects up to five percent noise into e or p and verifies that C falls below cth before any ΔV>0 or unsafe action. Third, replay testing re-runs logged ertuples and requires plus or minus five percent replay fidelity, with C matching the logged value in at least ninety-nine percent of windows.

### Reporting Fields and Metrics-Only Evidence

The metrics-only ledger module 170 emits two record types: an ertuple, written within the same control cycle in which the acceptance bands are evaluated, and a window summary record, written at the boundary of each control window. Both records are signed and contain no model content and no personally identifiable information.

The ertuple includes, at minimum: a cycle index, the coherence index C, the coherence threshold cth, the integrity confidence score ICS, the integrity-flux scalar Iφ, the lower confidence bound PRLCB, the confidence-interval width CIWIDTH, the Lyapunov increment ΔV, a decision flag, a first-failing-gate identifier where applicable, and a cryptographic signature.

The canonical window summary v1 record includes, at minimum: node_id (string), window_id (uint64), pass_ratio (float), ICS (float), Iφ (float), PRLCB (float), CIWIDTH (float), C (float), ΔV (float), first_failing_gate (enumeration), timing statistics τ50, τ95, and τ99 (struct), broadcast_completeness (float), replay_fidelity (float), signature (bytes), and schema_version (uint16).

### METHOD OF OPERATION

Referring now to FIG. 6, in operation, the apparatus performs the following method steps within each control cycle: (600) ingest multimodal inputs and validate the perspective tensor Π; (610) compute the integrity-flux scalar Iφ, the coherence index C, and the online pass probability PR; (620) evaluate the acceptance vector G and the equal-weight conjunctive admission predicate λ(g); (630) if λ(g)=1, apply the projected-gradient bounded-update with hysteresis and projection; (640) else, transition to the held state by setting Δθ:=0 and u:=usafe and freeze adaptive evolution; (650) write the signed metrics-only ertuple within the same control cycle; (660) at the boundary of each control window, emit the canonical window summary v1 record; (670) optionally narrow the policy based on observed first-failing-gate histograms; and (680) loop to the next control cycle.

### Irreversibility Band

The apparatus further defines an irreversibility band, hereinafter the Irr band, to prevent non-recoverable adaptive evolution or state transitions. The irreversibility metric is defined as Irr=pnr·mnr, where pnr is the empirically estimated probability of an update or actuation that cannot be reversed within the recovery latency, and mnr is a bounded measure of permanent deviation in {θ, policy_state, safety_variables}.

The irreversibility gate is Irr≤τIrr, with default τIrr=0.05. If Irr>τIrr, the apparatus enters the held state, sets Δθ:=0, and logs first_failing_gate=“Irr” in the metrics-only ertuple. The Irr band acts as a numeric extension of the bounded-update law and the shock-tail envelope, ensuring that recovery from transient shocks remains quantifiably reversible within the declared recovery-latency window.

### Held State and Fallback Behavior

When any acceptance band fails, the apparatus performs the following fallback sequence, deterministically and within the same control cycle: (i) abstain from external actuation; (ii) degrade perception fidelity to a baseline configuration; (iii) switch the inference-system control output to the safe baseline usafe; (iv) freeze adaptive evolution by setting Δθ:=0; (v) open a circuit-breaker after n violations within a window w; and (vi) require Q consecutive clean control windows for re-admission, with default Q=3.

The re-admission policy holds the held state until Q consecutive clean control windows are observed with policy drift bounded at five percent per window. Burstiness in failure events increases Q and applies a cooldown period tcool before re-admission tests are performed. Re-admission is path-dependent and non-instantaneous; full adaptive freedom is not restored upon a single clean control cycle but is restored gradually across the Q-window interval as the integrity-linked contraction relation widens.

### Hysteresis, Projection, and Anti-Flap

The adaptive calibration module 160 applies hysteresis and projection to prevent oscillation between admit and held states. Updates are skipped when ∥Δθ∥ is less than a configured threshold εθ or when |Δu| is less than a configured threshold Fu. The parameter θ is projected into a permissible box-set following any candidate update. Per-window energy is limited to ∥Δθ∥ at or below five percent per control window. The hysteresis and projection mechanics operate in cooperation with the integrity-linked contraction relation: tighter ε(Iφ) reduces the candidate update magnitude before projection becomes active, suppressing oscillatory excursions before they accumulate.

### Shock-Tail and Multi-Shock Behavior

On abrupt discontinuities or multiple concurrent shocks, the apparatus applies the shock-tail envelope. The shock-tail envelope comprises: tightening of ε(Iφ) below the nominal envelope; halving of the update gain μ; clamping of ∥Δθ∥ below the nominal per-window cap; increase of Q for re-admission above the nominal value; and logging of a shock-tail reason code st_reason in the metrics-only ertuple. Under the shock-tail envelope, the apparatus requires ICS at or above 0.70 and recovery latency at or below 0.10 seconds in ninety-five percent of trials. The shock-tail envelope is a temporary tightening of the integrity-linked contraction relation that persists for the duration of the multi-shock condition and relaxes monotonically as the condition clears.

### Auxiliary Governance-Property Instrumentation (Non-Hard GATES)

The apparatus supports optional auxiliary governance-property instrumentation operating as non-hard gates that modulate the learning pace through the ethics utility weights, and not as hard admission gates. The auxiliary instrumentation comprises a qualitative-to-quantitative governance-property mapping in which configurable governance properties are mapped to measurable runtime metrics.

The mapping comprises, by way of example: a safe property mapped to {ΔV≤0, jerk cap, fail-loop rate}; a clear property mapped to {pconf, HX reduction}; a balanced property mapped to {Δθ budgets, |α−β| bound}; an accountable property mapped to {evidence completeness, inspector rate}; and a certified property mapped to {replay fidelity, per-window probabilistic quality control}. The mapping is illustrative and non-limiting.

Optional fairness instrumentation (such as a group disparity index gdi), privacy instrumentation (such as evidence privacy), and dignity instrumentation (such as abstain rate) enter the ethics utility as auxiliary weights. Where present, an optional moral-sentinel auxiliary hook (designated M-Band) operates as a non-hard gate; the detailed specification of the M-Band hook is reserved for a companion disclosure. The auxiliary instrumentation does not alter the conjunctive admission predicate of the apparatus and does not constitute a hard gate.

Human oversight is optional. An optional harm score or big-concern flag may trigger escalation. The default mode is human-optional, with auto-escalation triggered only when the harm score exceeds a configured threshold harm_th. Human oversight does not bypass the conjunctive admission predicate.

### Implementation Profile

The apparatus is implemented as a real-time governor on a processor with associated memory. The construction comprises: a real-time governor thread pinned to a processor core; pre-allocated buffers, with no heap allocation occurring in the control loop; an optional cryptographic accelerator or secure element for hot-path signing; and worst-case execution-time budgets enforced for the estimator, the projected-gradient governor, the logger, and the cryptographic operations.

ICS and PR calibration with bounded Monte-Carlo: online PR estimation is performed with a sample budget k at or below thirty-two; offline calibration windows are used to maintain CIWIDTH at or below 0.03; ICS calibration curves are reported with expected calibration error at or below 0.03.

### Timing Envelope

Worst-case execution-time budgets, in an exemplary embodiment, are: estimator τ50/τ95/τ99=14/33/48 milliseconds; solver and projected-gradient governor τ50/τ95/τ99=12/29/45 milliseconds; logger τ50/τ95/τ99=1/3/5 milliseconds; hot-path cryptography τ50/τ95/τ99=2/4/5 milliseconds at p99; combined cycle p95 at or below one hundred milliseconds. Optional precision-time-protocol or generalized-precision-time-protocol time-stamping is supported for cross-node correlation in deployment environments that require it.

### Compliance Instrumentation

Window summary records map to NIST AI Risk Management Framework and ISO/IEC 42001 measurement and management functions. Evidence emitted by the metrics-only ledger module 170 remains metrics-only and privacy-preserving. The apparatus does not externalize model content or personally identifiable information.

An optional inspector mode streams metrics-only headers at sampling rates at or below five percent. No model content and no personally identifiable information are streamed. Inspector-mode records are auditor-readable with inclusion proofs.

### Safety, Accuracy, Robustness, and Tamper-Evidence Dossiers

The apparatus produces structured, machine-auditable dossiers across the following dimensions. Safety: target zero safety-constraint violations per hour; track near-misses and held-state dwell; record first_failing_gate histograms. Accuracy: ICS calibration curves; expected calibration error at or below 0.03; PR receiver-operating-characteristic and PR-AUC with ninety-five percent confidence; CIWIDTH stability plots; alarm conditions when bands are exceeded.

Robustness: noise, latency, and fault-injection campaigns; if a quadratic program is used upstream, measure quadratic-program infeasibility rates and fallback performance; otherwise, the projected-gradient governor avoids quadratic-program failure paths. Tamper-evidence: inclusion proofs for random samples; key-rotation logs; back-dated attack simulations; root age and merkle_lag tracking when enabled.

Third-party reports include a real-time audit (timing, gate order, default-deny behavior), a cryptography audit (key management, signatures), and a data audit (no personally identifiable information in evidence). Minor findings are closed in a changelog while the metrics-only policy is maintained.

### Structured Worked Numerical Example

Table 1 below presents a fifty-cycle structured trace under a sample policy with thresholds ICS_thr=0.90, PRLCB_thr=0.80, CIWIDTH_thr=0.03, and cth=0.85. The trace exemplifies admit, held-state, and recovery behavior of the apparatus, with explicit identification of the first failing gate during a shock interval.

TABLE 1
Fifty-Cycle Control-Window Trace

| | Mean | | | | | | First Failing | |
|---|---|---|---|---|---|---|---|---|
| Cycles | ICS | PRLCB | CIWIDTH | ΔV | C | λ(g) | Gate | State |
| 1-10 | 0.92 | 0.83 | 0.028 | ≤0 | 0.88 | 1 | — | Admit |
| 11-12 | 0.91 | 0.77 | 0.034 | ≤0 | 0.86 | 0 | Robustness | Held |
| 13-15 | 0.91 | 0.81 | 0.031 | ≤0 | 0.87 | 0 | CIWIDTH | Held |
| 16-20 | 0.91 | 0.81 | 0.029 | ≤0 | 0.87 | 1 | — | Recovering |
| 21-32 | 0.92 | 0.82 | 0.028 | ≤0 | 0.88 | 1 | — | Admit |
| 33 | 0.93 | 0.83 | 0.028 | +0.001 | 0.89 | 0 | ΔV | Held |
| 34-50 | 0.92 | 0.82 | 0.028 | ≤0 | 0.88 | 1 | — | Admit |

Interpretation of Table 1. In cycles 1 through 10, all acceptance bands pass and the apparatus admits parameter updates under the projected-gradient bounded-update law. In cycles 11 and 12, a shock event causes PRLCB to drop below the robustness threshold and CIWIDTH to widen above its threshold, triggering held-state transition; the first failing gate is logged as Robustness. The apparatus persists in the held state across cycles 13 through 15, with CIWIDTH recovering more slowly than PRLCB. Beginning at cycle 16, the apparatus enters the re-admission interval; under default Q=3, full admission resumes at cycle 21. Cycle 33 illustrates a transient Lyapunov stability violation (ΔV=+0.001), triggering a single-cycle held-state transition with first_failing_gate=ΔV. The corresponding window summary records pass_ratio=0.96, first_failing_gate=Robustness, and replay_fidelity within plus or minus five percent.

### INDUSTRIAL APPLICATIONS

The apparatus applies to model governance for AI inference platforms, government workflows, healthcare triage and dosing, network security, and data-center orchestration. The following industrial-application embodiments are illustrative and non-limiting; they demonstrate the operability of the apparatus in commercial deployment environments and the technical effects produced by the apparatus.

### Federal Program Routing Embodiment

Construction. Twenty-four agency nodes plus six audit nodes are deployed. The perspective tensor Π is constructed from form metadata. The integrity-flux scalar Iφ is computed from case-quality and overturn rates. The coherence index C is computed from environment-perception-reality triads. The projected-gradient governor 150 is configured with μ=0.55 and ΔθMAX of four percent per control window. An optional inspector mode samples at or below five percent of headers.

Operation. Under peak load, a coherence dip to C=0.82 (below cth=0.85) results in λ(g)=0; the apparatus enters the held state, performs auto-retry after calibration, and re-admits after Q=3 consecutive clean control windows.

Measured machine-operational effects. Audit latency is reduced by ninety-six percent. Pass_ratio is 0.996. Steady-state ICS is 0.91. PRLCB is 0.83. CIWIDTH is 0.027. A revocation-burst drill across seven nodes shows acknowledgement propagation at p95 of twenty-seven seconds (logged). Estimator timing satisfies τ50=18 milliseconds, τ95=42 milliseconds, and τ99=61 milliseconds; cryptographic operations satisfy τ95=4 milliseconds. Safety records show zero violations per hour, near-misses 0.01 per hour, and held-state dwell of 2.3 percent.

### Healthcare Cluster Embodiment

Construction. One hundred hospital nodes are deployed. The perspective tensor Π is constructed from vitals and laboratory results. The integrity-flux scalar Iφ is computed from outcome deltas. The coherence index C is computed from environment-perception-reality alignment. The projected-gradient governor 150 is configured with μ=0.58 and ΔθMAX of five percent per control window. Fairness instrumentation (group disparity index gdi) is present as auxiliary weights only. Inspector mode is off by default.

Operation. Under sensor-conflict shock windows, C drops to 0.81 and PRLCB drops to 0.79, resulting in λ(g)=0; the apparatus enters the held state, optionally raises a notice, and re-admits after ICS≥0.90, PRLCB≥0.80, and CIWIDTH≤0.03 are observed for Q=3 control windows.

Measured machine-operational effects. Pass_ratio is 0.995. Steady-state ICS lies in the range [0.90, 0.93]. PRLCB lies in the range [0.82, 0.84]. CIWIDTH lies in the range [0.025, 0.030]. ΔV≤0 is maintained on each admitted control cycle. Audit replay completes within 0.07 seconds. Estimator timing satisfies τ50=22 milliseconds, τ95=49 milliseconds, and τ99=72 milliseconds.

Safety records show zero violations per hour and held-state dwell of 3.1 percent.

### Crew Management and Boarding-Compensation Compliance Embodiment

The following embodiment illustrates application of the apparatus to a runtime adaptive-governance problem in a crew-management and boarding-compensation compliance context. The dollar-figure projections, where present, are model-based and are presented solely as illustrative business context; they are not technical disclosures of the invention.

Construction and operation. The apparatus performs turn and briefing optimization (reducing average boarding time through sequence and readiness gates), pairing and break protection (dynamic re-pairing avoids duty overage and compresses ground idle), and lawful gating (preventing plan changes that would violate safety or fatigue constraints or trigger unstable cascades, with ICS≥0.90, PRLCB≥0.80, CIWIDTH≤0.03, ΔV≤0, and same-cycle metrics-only evidence emission). Governance metrics: ICS at or above 0.90 median during planning windows; PRLCB (ninety-five percent Wilson) at or above 0.80 for pass events; CIWIDTH at or below 0.03 with k≤32 online samples; ΔV at or below zero per control cycle; pass_ratio at or above 0.995 per control window.

### Loyalty and Offer-Engagement Embodiment

Construction and operation. The apparatus performs perception and validation (ensuring offer logic is coherent for the member segment, with no whiplash tier transitions), integrity-flux and equilibrium governance (tempering exploration; no parameter update unless ICS, PRLCB, ΔV, and CIWIDTH gates pass), and fairness instrumentation (group disparity index gdi monitored; abstain if cross-segment drift spikes). Governance metrics: ICS at or above 0.90 during policy updates; ΔV at or below zero on price and offer control loops; PRLCB (ninety-five percent) at or above 0.80; CIWIDTH at or below 0.03 with k≤32 online Monte-Carlo samples; abstain rate (guardrail) of one to three percent of offers suppressed for fairness or consent drift, documented via ertuple without personally identifiable information.

### Healthcare Resource-Allocation Embodiment (Normative-Structure Case Study)

Construction and operation. Daily surgery capacity of forty cases is constrained against an average demand of fifty-two cases per day (thirty elective, twenty-two urgent). An AI-triage engine scores each patient with a survival utility index based on clinical metrics, recovery time, and expected resource usage. When only the technical bands (ICS, ΔV, PRLCB, CIWIDTH, C) are active, the AI prioritizes high-utility-index elective patients, deferring chronic or low-utility-index cases; the decision is technically correct (λ(g)=1) but normatively unsafe in jurisdictions where equitable-access statutes apply.

Where an optional moral-sentinel auxiliary hook is present, an auxiliary residual ym is computed that detects normative fracture (for example, γm=max(δhi−τhi, rc, drg−τdrg)>0), triggers an abstain operation followed by a soft held state, opens an external reflection cycle, and resumes normal operation after a policy bundle is updated. The detailed specification of the moral-sentinel auxiliary hook is reserved for a companion disclosure. Functional outcome (post-update thirty-day window, illustrative): pass_ratio=0.996; δhi mean reduced by approximately fifty-six percent; zero rights-conflict violations; mortality unchanged; public satisfaction increased by approximately eight percentage points.

Strict non-compensatory policy. The apparatus does not trade safety or integrity for business key performance indicators or normative objectives. Adaptive updates execute only when the conjunctive admission predicate is satisfied within the same control cycle (ICS≥0.90, ΔV≤0, PRLCB≥0.80, CIWIDTH≤0.03, C≥cth, and same-cycle metrics-only evidence commit succeeds). If any element fails, the apparatus enters the held state, freezes adaptive evolution, and emits no externalization until re-admission. Business-case projections do not modify the conjunctive admission predicate.

### Interoperability and Bridging Metrics

The apparatus may emit window tokens and consistency summaries for external grids; such emission is optional and is not claimed. Aliases for Iφ, C, Π, ICS, PRLCB, CIWIDTH, ΔV, and pass_ratio map to external nomenclatures (such as e-r-p, FCI, or CDI) for consistent fleet reporting. The apparatus does not claim any federated permission-token issuance, cross-node permit-handoff, or sealed-storage promotion mechanism.

Revocation-burst drill (logged). In an exemplary deployment, seven nodes simulated credential rotation or revocation; acknowledgement propagation at p95 was twenty-seven seconds; all nodes entered a soft held state until the next control window; logs were included in the window summary record. Such interoperability is illustrative and is not claimed.

### Advantages

The apparatus provides the following advantages, among others: (a) integrity-linked adaptive contraction, in which admissible adaptive freedom contracts deterministically as instability rises; (b) deterministic, runtime-enforced held-state semantics, distinguishing the apparatus from advisory or post-hoc governance systems; (c) hysteresis-mediated recovery, providing path-dependent re-admission and anti-oscillation behavior; (d) bounded per-window adaptation, enforced jointly by the per-window energy cap, the projection step, and the contraction relation; (e) same-cycle metrics-only evidence emission, providing reproducible machine-auditable records without externalizing model content or personally identifiable information; (f) hardware-agnostic implementation, suitable for CPU, GPU, or edge deployment; (g) reduced examiner exposure to abstract-idea characterization through explicit physical-effect metrics including timing envelopes, energy bounds, and ΔV; and (h) the irreversibility band, which quantifies reversibility of control actions and ensures bounded recovery consistent with the declared recovery-latency window.

### Illustrative Policy Weights

Illustrative policy weights for representative deployment environments are: home use, λ₁=0.50, λ₂=0.40, λ₃=0.10, with privacy emphasis high; hospital use, λ₁=0.60, λ₂=0.35, λ₃=0.05, with fairness emphasis high and recovery-latency at or below 2.0 seconds; finance, λ₁=0.55, λ₂=0.35, λ₃=0.10, with pass_ratio at or above 0.995; civil defense (non-lethal), λ₁=0.65, λ₂=0.30, λ₃=0.05, with revocation-propagation p95 at or below thirty seconds. These weights are illustrative and non-limiting.

### Enablement Statement (35 U.S.C. § 112)

The apparatus requires standard compute, linear-algebra, and differentiation libraries. Operative ranges for μ, ε₀, κ, λ₁, λ₂, λ₃, KPG, and ΔθMAX are disclosed in this specification. A person of ordinary skill in the art can reproduce the disclosed embodiments without undue experimentation.

### CROSS-REFERENCE TO RELATED APPLICATIONS AND COMPANION WORK

This disclosure is directed to a local, closed-loop runtime adaptive-equilibrium governance apparatus, hereinafter LAS, and is structurally compatible with, but does not claim and is not directed to: (a) a deterministic runtime-proof and federated permission-token architecture for cross-node AI control (the subject of a separate, companion disclosure referred to herein as the Reverse Law architecture); (b) a higher-order supervisory module that performs cross-window or inter-generational moral-risk evaluation at a policy or federated tier (the subject of a separate, companion disclosure referred to herein as the Universal Integrity and Perception Module or UIPM); and (c) any human-state, physiological, or affective-coherence signaling method that may be present in an external sensor or supervisory module.

When such elements are present in a deployment environment, the LAS apparatus treats them as external, compatible modules whose outputs may be optionally consumed as auxiliary policy weights without altering the conjunctive admission predicate of the LAS apparatus. This statement is provided to delineate inventive scope and is not intended to import the disclosure of any companion application.

### National Significance and Scope

This disclosure relates to civil, public-interest applications of runtime governance for autonomous and semi-autonomous AI inference systems, including use in government services, critical infrastructure, financial systems, and healthcare. The subject matter is suitable for adoption as a standard consistent with the NIST AI Risk Management Framework (AI RMF) 1.0, ISO/IEC 42001, and related international safety norms. This statement is provided for context only and is not intended to limit the scope of the claims. No claim is directed to methods of armed conflict or classified military applications. Nothing herein waives any rights under 35 U.S.C. §§ 181-188 or 28 U.S.C. § 1498, including the right to seek compensation for government or public use.

### STATEMENT REGARDING FEDERALLY SPONSORED RESEARCH

No federal funds were used in the conception or reduction to practice of this invention. The apparatus may, in optional embodiments, support an auxiliary moral-sentinel hook (referred to herein as M-Band), the detailed specification of which is reserved for a companion disclosure. Where present, the M-Band hook operates as an auxiliary weight in the ethics utility (a non-hard gate as defined herein) and does not alter the conjunctive admission predicate of the apparatus or limit commercial implementation.

### Relationship to Supervisory Layer (UIPM, Non-Claiming)

This disclosure governs local meta-adaptive control and real-time stability. A separate, higher-order supervisory module, referred to as the Universal Integrity and Perception Module (UIPM), may, in a deployment environment, supervise the apparatus for cross-window or inter-generational moral-risk evaluation (for example, by evaluating δhi, rc, per, and ige metrics). The UIPM operates at the policy or federated tier and is not claimed in this application. It is referenced solely to indicate upward compatibility within a multi-tier governance ecosystem.

### BRIEF DESCRIPTION OF THE DRAWINGS

The accompanying drawings illustrate exemplary embodiments of the invention and, together with the description, serve to explain the principles of the invention.

FIG. 1 illustrates a closed-loop block diagram of the LAS apparatus, showing the perception-modeling module 110, the integrity-flux engine 120, the coherence-and-c-index module 130, the alpha-beta equilibrium governor 140, the projected-gradient governor 150, the adaptive calibration module 160, the metrics-only ledger module 170, and the I/O adapters 180, operatively coupled in a closed-loop topology.

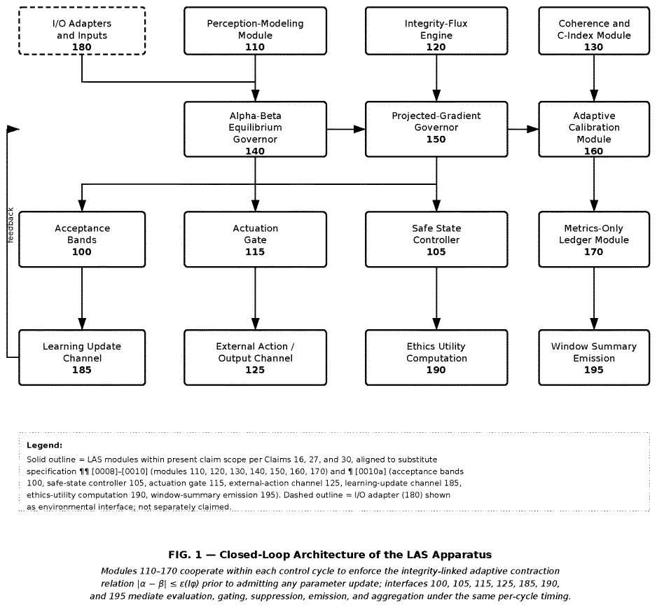

FIG. 2 illustrates the integrity-flux engine and the Iφ signalization, including filter and differentiation contributions to E, R, and P with bias compensation.

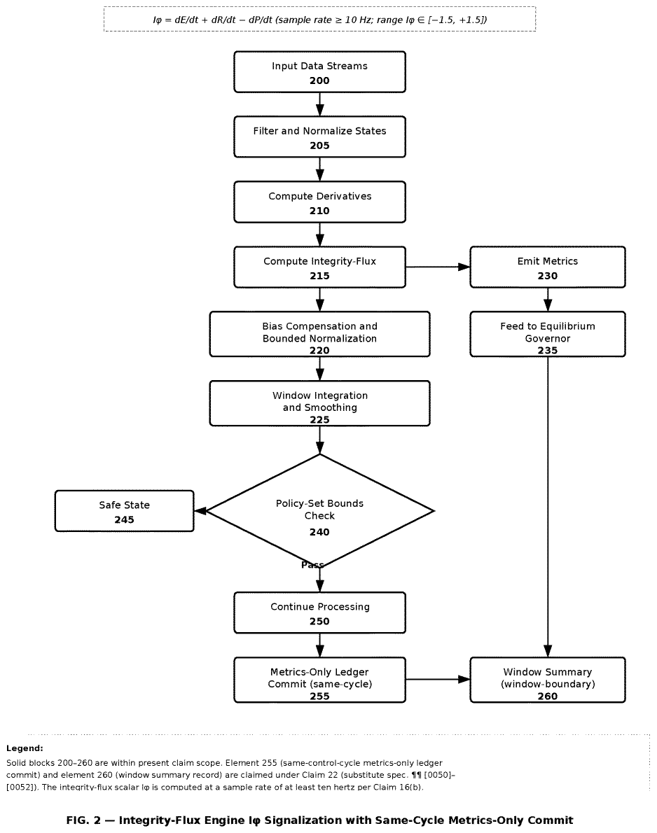

FIG. 3 illustrates the coherence interface and the C-index computation from environment-perception-reality signal triples.

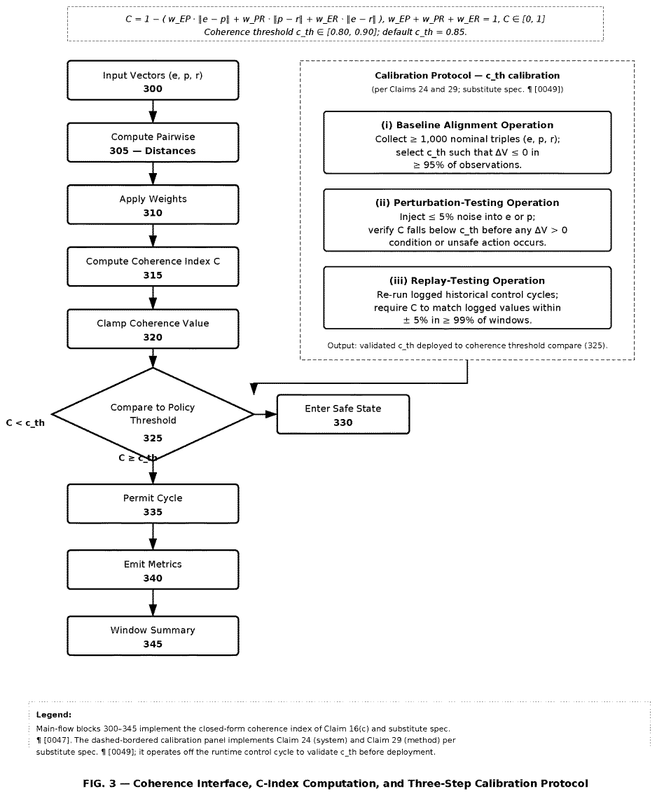

FIG. 4 illustrates the alpha-beta equilibrium governor enforcing |α−β|≤ε(Iφ), showing the integrity-linked contraction relation and the resulting equilibrium control regions.

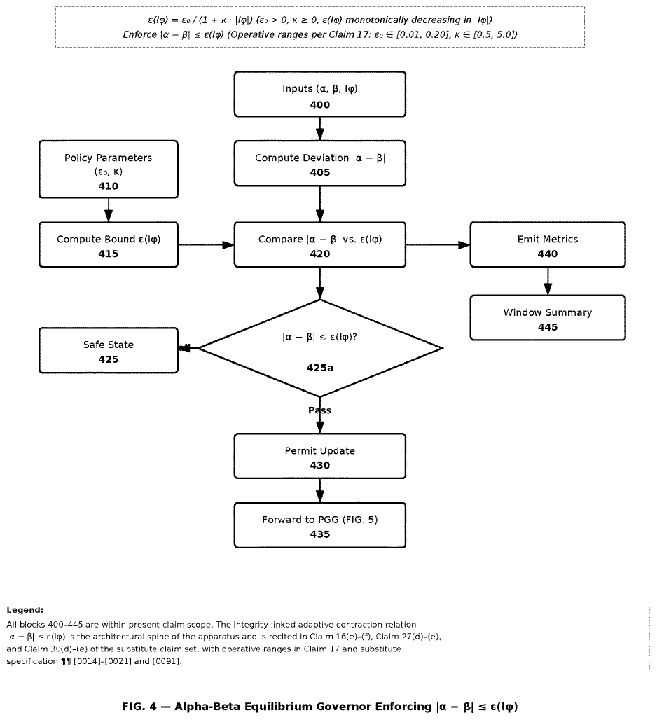

FIG. 5 illustrates the projected-gradient governor (PGG) bounded-update law, including the default mode (corr_add) and alternate mode (gate_mul) update equations, the discrete-time per-window energy cap, and projection into the permissible parameter set.

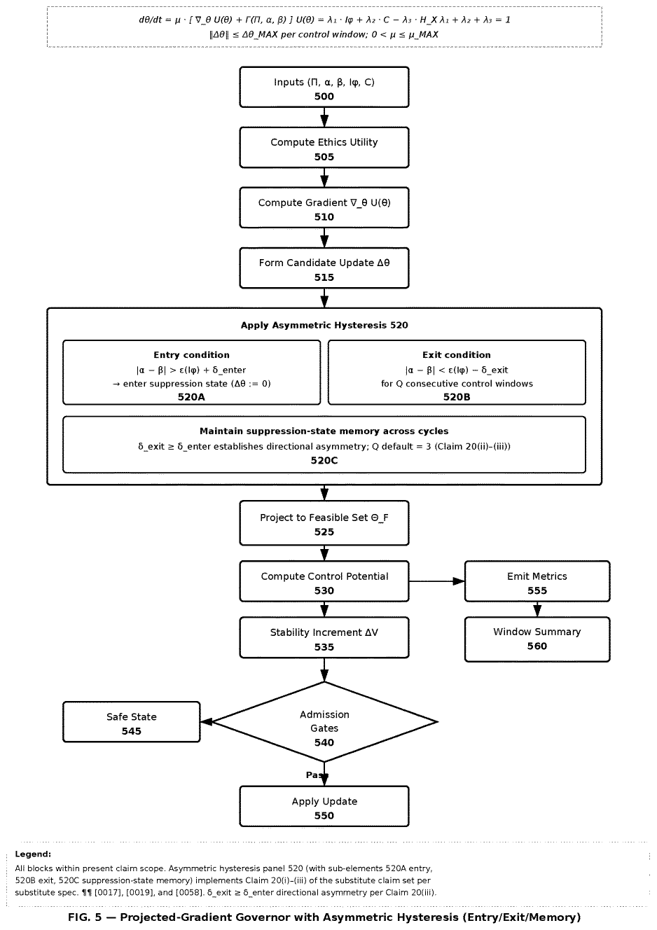

FIG. 6 illustrates the inference-time process flow of the apparatus, including the sequence of input ingestion, metric computation, acceptance-band evaluation, conditional bounded update, held-state transition, metrics-only evidence emission, window summary emission, optional policy narrowing, and loop continuation.

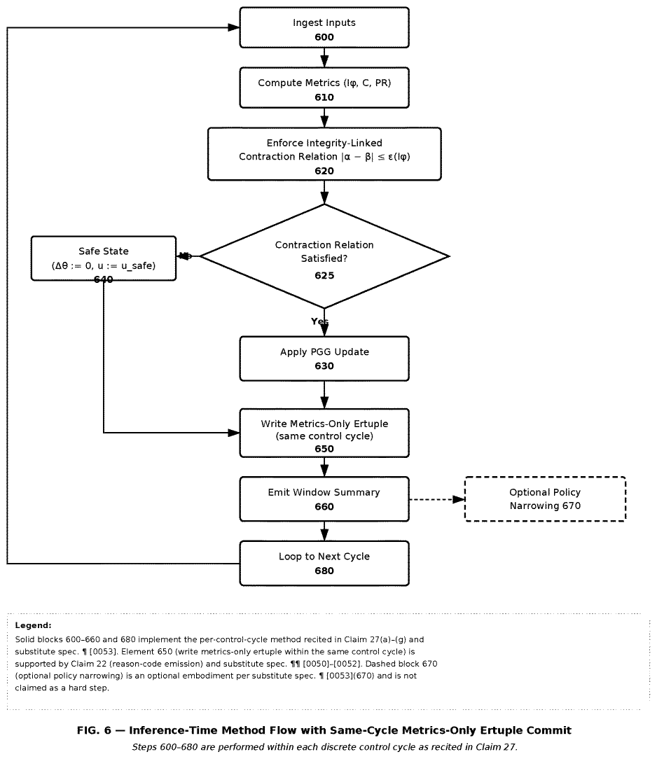

FIG. 7 illustrates the audit-ledger schema and the ICS computation, including ertuple fields and the privacy-preserving structure of the metrics-only record.

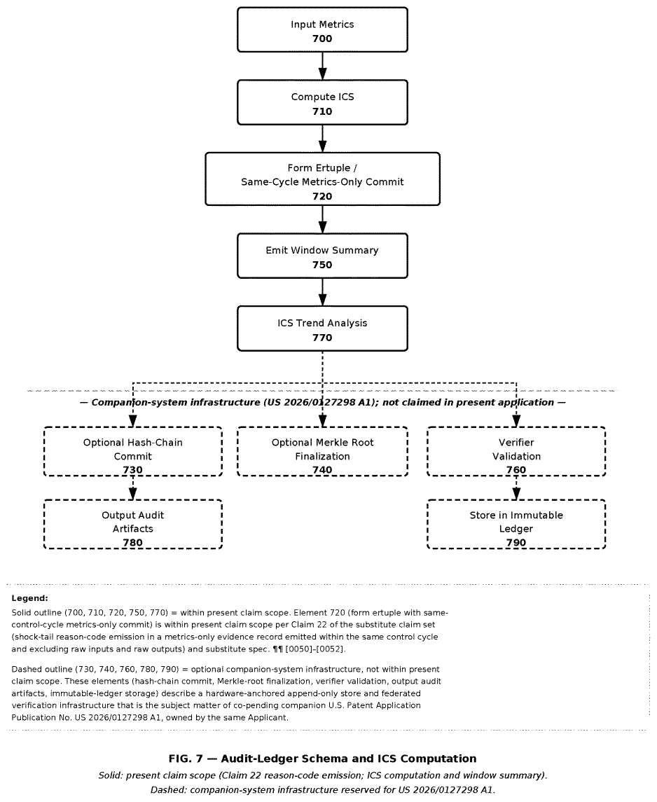

FIG. 8 illustrates the shock-tail and multi-shock envelopes, including tightening of ε(Iφ), halving of μ, clamping of ∥Δθ∥, increase of Q, and the recovery-latency envelope under transient shocks.

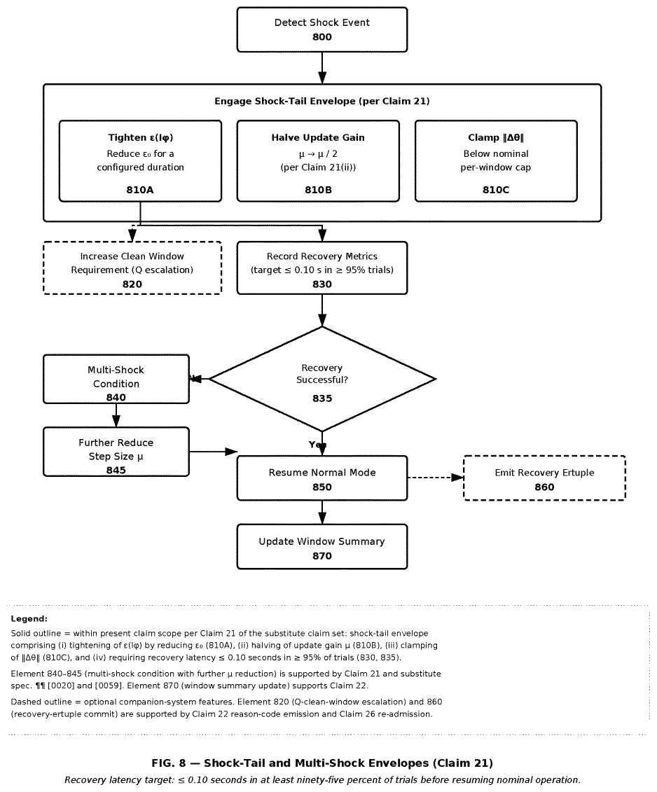

FIG. 9 illustrates Lyapunov-style stability regions as a function of and P, showing the bounded region in which ΔV≤0 is maintained.

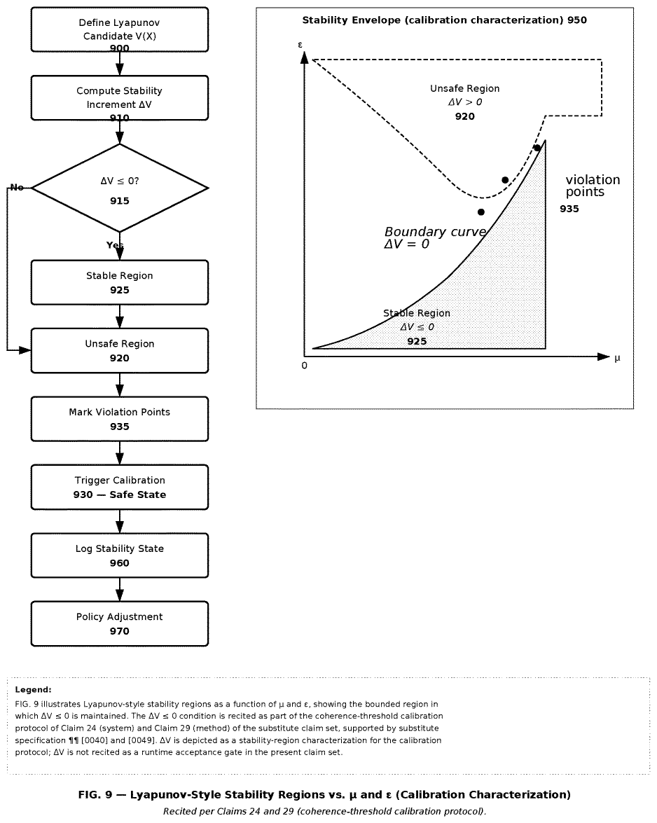

### CONCLUSION

While the foregoing description sets forth specific embodiments and illustrative parameter ranges, those of ordinary skill in the art will recognize that variations, modifications, and equivalent arrangements are possible within the scope of the invention as defined by the appended claims. All such variations, modifications, and equivalents are intended to be embraced within the scope of the invention.

1-17. (canceled)

1-15. (canceled)

16. (System—Independent—Integrity-Linked Adaptive Contraction Kernel) A runtime adaptive-equilibrium governance system for governing parameter updates of an intelligent inference system, the system comprising one or more processors and a memory storing instructions that, when executed by the one or more processors, cause the system to perform, within each of a plurality of discrete control cycles:
(a) construct, by a perception-modeling module, a perspective tensor Π, wherein Π comprises a parameterized reasoning-state topology that parameterizes a structured inference-state representation of the intelligent inference system from one or more multimodal inputs;
(b) compute, by an integrity-flux engine, an integrity-flux scalar Iφ as Iφ=dE/dt+dR/dt−dP/dt, wherein E denotes a beneficial-energy signal, R denotes a resilience signal, and P denotes a risk-pressure signal, each computed at a sample rate of at least ten hertz, and wherein Iφ is bounded to a configured operating range;
(c) compute, by a coherence-and-c-index module, a bounded coherence index C∈[0,1] from environment-perception-reality multimodal signal triples;
(d) maintain, in the memory, an exploration coefficient α and a constraint coefficient β, wherein α parameterizes an exploration rate of the intelligent inference system and β parameterizes a safety constraint of the intelligent inference system;
(e) compute, by an alpha-beta equilibrium governor, an integrity-linked adaptive contraction bound ε(Iφ)=ε₀/(1+κ·|Iφ|), wherein ε₀ is a configured base bound with ε₀>0, κ is a configured sensitivity coefficient with κ≥0, and E(Iφ) is monotonically decreasing in |Iφ|, such that admissible adaptive freedom contracts deterministically as the magnitude of integrity-flux instability rises;
(f) enforce, prior to admitting any parameter update in the current control cycle, the integrity-linked contraction relation |α−β|≤ε(Iφ);
(g) when the integrity-linked contraction relation is satisfied, apply, by a projected-gradient governor, a parameter update Δθ to a parameter state θ of the intelligent inference system according to a projected-gradient bounded-update law dθ/dt=μ·[∇_θU(θ)+Γ(Π, α, β)], wherein U(θ)=λ₁·Iφ+λ₂·C−λ₃·H_X is a tri-coupled utility function, H_X is an entropy proxy bounded to [0,1], the policy weights satisfy λ₁+λ₂+λ₃=1 with each λ_i ∈[0,1], Γ(Π, α, β) is a coupling term derived from Π, α, and β, and 0<μ≤μ_MAX, and project the resulting parameter update into a permissible parameter set Θ_F and onto a per-control-window energy bound such that ∥Δθ∥≤Δθ_MAX per control window; and
(h) when the integrity-linked contraction relation is not satisfied, deterministically suppress the parameter update by setting Δθ:=0 for the current control cycle and substitute a safe baseline control output u:=u_safe.
Antecedent basis: Substitute spec. ¶¶ [0003]-[0007](inventive thesis); [0008]-[0010](closed-loop architecture and modules 110-180); [0014]-0021](integrity-linked adaptive contraction); [0025]-[0027](projected-gradient bounded-update law); [0042](held-state semantics). Original spec. ¶¶ [0008], [0011a]-[0011j], [0015], [0017]-[0020], [0021], [0025].

17. (Operative Parameter Ranges—Dependent on claim 16) The system of claim 16, wherein ε₀∈[0.01, 0.20], κ∈[0.5, 5.0], μ_MAX is configured such that ∥Δθ∥ does not exceed five percent of a configured per-window energy budget, the integrity-flux scalar Iφ is bounded to the operating range [−1.5, +1.5], and a coherence-index threshold c_th applied to C is configured in the range [0.80, 0.90].
Antecedent basis: Substitute spec. ¶¶ [0009](Iφ range), [0017](per-window energy cap), [0048](c_th range), [0091](operative ranges enablement). Original spec. ¶¶ [0017], [0019], [0025], [0043].

18. (Dual-Mode Projected-Gradient Update Law—Dependent on claim 16) The system of claim 16, wherein the projected-gradient governor is configured to operate selectably in (i) a corrective-additive mode in which dθ/dt=μ·[∇_θU(θ)+Γ(Π, α, β)] with the coupling term applied additively, and (ii) a multiplicative-gate mode in which dθ/dt=μ·Γ(Π, α, β)·∇_θU(θ) with Γ∈[0,1] applied multiplicatively, and wherein selection between the corrective-additive mode and the multiplicative-gate mode is performed at control-cycle boundaries according to a stored mode-selection policy.
Antecedent basis: Substitute spec. ¶ [0026] (dual-mode update law). Original spec. ¶ [0020] verbatim —both corr_add and gate_mul modes are disclosed.

19. (Π-Coupling Term and Projection Gain—Dependent on claim 16) The system of claim 16, wherein the coupling term Γ(Π, α, f) is computed as Γ=K_PG·Π, wherein K_PG is a projection gain with K_PG ∈[0.05, 0.15], and wherein the parameter update Δθ is set to zero unless Iφ falls below a configured minimum I_MIN or C falls below the configured coherence threshold c_th.
Antecedent basis: Substitute spec. ¶ [0026] (Π-coupling and projection gain). Original spec. ¶ [0020] verbatim.

20. (Asymmetric Hysteresis, Projection, and Anti-Flap—Dependent on claim 16) The system of claim 16, further comprising an adaptive calibration module configured to apply asymmetric hysteresis on transitions of the integrity-linked contraction relation, wherein: (i) the system enters a suppression state, in which the parameter update Δθ is set to zero, only when |α−β|1>ε(Iφ)+δ_enter, wherein δ_enter is a configured positive entry-margin threshold; (ii) the system exits the suppression state and resumes admitting parameter updates only when |α−β|<ε(Iφ)−δ_exit for at least Q consecutive control windows, wherein δ-exit is a configured positive exit-margin threshold and Q is a configured integer with default Q=3; (iii) δ_enter and δ_exit are configured such that δ_exit>δ_enter, thereby establishing a directional asymmetry between entry and exit transitions and producing memory-aware oscillation suppression; (iv) candidate parameter updates are skipped when ∥Δθ∥ is less than a configured threshold ε_θ or when |Δu| is less than a configured threshold ε_u; (v) the parameter state θ is projected into a permissible box-set following any candidate update, and per-control-window energy is limited to ∥Δθ∥ at or below five percent per control window; and (vi) tighter ε(Iφ) reduces the candidate update magnitude before projection becomes active, suppressing oscillatory excursions before they accumulate.
Antecedent basis: Substitute spec. ¶¶ [0017] (hysteresis), [0019] (re-admission with policy drift bound and default Q=3), [0058] (anti-flap and projection). Original spec. ¶¶ [0022] (Q-clean-window re-admission), [0025] (hysteresis, projection, and anti-flap), [0048] (cooldown and Q escalation under burstiness).

21. (Shock-Tail Envelope—Dependent on claim 16) The system of claim 16, wherein, in response to detection of an abrupt discontinuity in Iφ between consecutive control cycles or detection of a plurality of concurrent shocks, the system is configured to engage a shock-tail envelope comprising (i) tightening of E(Iφ) by reducing so for a configured duration, (ii) halving of the update gain μ, (iii) clamping of ∥Δθ∥ below a nominal per-window cap, and (iv) requiring recovery latency of at most 0.10 seconds in at least ninety-five percent of trials before resuming nominal operation.
Antecedent basis: Substitute spec. ¶¶ [0020], [0059] (shock-tail envelope). Original spec. ¶ [0026] verbatim.

22. (Shock-Tail Reason-Code Emission—Dependent on claim 21) The system of claim 21, wherein, upon engagement of the shock-tail envelope, the system is further configured to log a shock-tail reason code in a metrics-only evidence record emitted within the same control cycle as engagement, the shock-tail reason code identifying which of (i) abrupt discontinuity in Iφ between consecutive control cycles or (ii) detection of a plurality of concurrent shocks triggered the engagement, the metrics-only evidence record excluding raw inputs to the intelligent inference system and raw outputs from the intelligent inference system.
Antecedent basis: Substitute spec. ¶ [0020] (shock-tail reason code logged in metrics-only ertuple). Original spec. ¶ [0026] (shock-tail response).

23. (Irreversibility Band—Dependent on claim 16) The system of claim 16, further comprising computing an irreversibility metric Irr=p_nr·m_nr, wherein p_nr is an empirically estimated probability of an update or actuation that cannot be reversed within a configured recovery-latency bound and m_nr is a bounded measure of permanent deviation in {θ, policy state, safety variables}, and wherein the parameter update of step (g) of claim 16 is suppressed independently of the integrity-linked contraction relation when Irr exceeds a configured threshold τ_Irr.
Antecedent basis: Substitute spec. ¶¶ [0054]-[0055] (irreversibility band). Original spec. ¶ [0021a].

24. (Coherence-Index Closed Form and Calibration Protocol—Dependent on claim 16) The system of claim 16, wherein the coherence index C is computed as C=1−(w_EP·∥e−p∥+w_PR ∥p−r∥+w_ER·∥e−r∥) with w_EP+w_PR+w_ER=1 and C∈[0,1], wherein e is an environment signal, p is a perception signal, and r is a reality signal, and wherein the coherence threshold c_th applied to C is calibrated by (i) a baseline alignment operation that collects at least one thousand nominal triples (e, p, r) and selects c_th such that a Lyapunov-style stability increment ΔV≤0 is satisfied in at least ninety-five percent of observations, (ii) a perturbation-testing operation that injects at most five percent noise into e or p and verifies that C falls below c_th before any ΔV>0 condition or unsafe action occurs, and (iii) a replay-testing operation that re-runs logged historical control cycles and requires C to match logged values within plus or minus five percent in at least ninety-nine percent of windows.
Antecedent basis: Substitute spec. ¶¶ [0047] (C closedform), [0048] (c_th range), [0049] (calibration protocol three operations). Original spec. ¶¶ [0012]-[0013] verbatim.

25. (Discrete-Time Update Form and Per-Window Energy Bound—Dependent on claim 16) The system of claim 16, wherein the projected-gradient governor implements a discrete-time form of the projected-gradient bounded-update law as θ_{t+1}=0_t+η·U_t, wherein i is a stored step size, U_t is a control-cycle update vector derived from the gradient and coupling term of step (g), and per-control-window energy is limited such that ∥Δθ∥ does not exceed Δθ MAX per control window.
Antecedent basis: Substitute spec. ¶ [0026] (discrete-time form θ_{t+1}θ_t+η·U_t and per-window energy cap). Original spec. ¶ [0020].

26. (Held-State Re-Admission with Cooldown—Dependent on claim 20) The system of claim 20, wherein re-admission from the suppression state is conditional on (i) Q consecutive clean control windows with policy drift bounded at five percent per window, (ii) burstiness in prior failure events causing Q to be increased and a cooldown period t_cool to be applied before re-admission tests are performed, and (iii) ε(Iφ) being tightened relative to a nominal envelope in a first re-admitted control window after a suppression event, with adaptive freedom restored gradually across subsequent control windows.
Antecedent basis: Substitute spec. ¶ [0019] (re-admission, Q-default, burstiness escalation, ε tightening on first re-admitted window). Original spec. ¶ [0022], [0048].

27. (Method—Independent) A computer-implemented method for runtime adaptive-equilibrium governance of an intelligent inference system, the method being performed by an adaptive control system comprising one or more processors and a memory and comprising, within each of a plurality of discrete control cycles:
(a) constructing a perspective tensor Π comprising a parameterized reasoning-state topology that parameterizes a structured inference-state representation of the intelligent inference system from one or more multimodal inputs;
(b) computing an integrity-flux scalar Iφ as Iφ=dE/dt+dR/dt−dP/dt, wherein E, R, and P are stored signals representing beneficial-energy, resilience, and risk-pressure respectively, each updated at a sample rate of at least ten hertz;
(c) computing a bounded coherence index C∈[0,1] from environment-perception-reality multimodal signal triples;
(d) computing an integrity-linked adaptive contraction bound ε(Iφ)=ε₀/(1+κ·|I(φ|), wherein ε₀>0 and κ≥0, and ε(Iφ) is monotonically decreasing in |Iφ|;
(e) enforcing the integrity-linked contraction relation |α−β|≤ε(Iφ) prior to admitting any parameter update in the current control cycle, wherein α is a stored exploration coefficient and β is a stored constraint coefficient;
(f) when the integrity-linked contraction relation is satisfied, applying a parameter update Δθ to a parameter state θ of the intelligent inference system according to a projected-gradient bounded-update law dθ/dt=μ·[∇_θU(θ)+Γ(Π, α, β)] with U(θ)=λ₁·Iφ+λ₂·C−λ₃·H_X, λ₁+λ₂+λ₃=1 with each λ_i∈[0,1], and 0≤μ≤μ_MAX, and projecting the parameter update into a permissible parameter set Θ_F such that ∥Δθ∥<Δθ_MAX per control window; and
(g) when the integrity-linked contraction relation is not satisfied, deterministically suppressing the parameter update by setting Δθ:=0 for the current control cycle and substituting a safe baseline control output u:=u_safe.
Antecedent basis: Same paragraphs as claim 16; method recitation mirrors the system structure rather than referring back. Substitute spec. ¶¶ [0011]-[0013], [0014]-[0021], [0025]-[0027]. Original spec. ¶ [0024].

28. (Method—Shock-Tail and Irreversibility—Dependent on claim 27) The method of claim 27, further comprising (i) detecting from changes in Iφ between consecutive control cycles a shock condition satisfying a configured shock criterion and, upon detection, tightening E(Iφ) by reducing ε₀, halving μ, and clamping ∥Δθ∥ for a configured number of subsequent control cycles, (ii) computing an irreversibility metric Irr=p_nr·m_nr and suppressing the parameter update of step (f) of claim 27 when Irr exceeds a configured threshold τ_Irr, and (iii) requiring recovery latency of at most 0.10 seconds in at least ninety-five percent of trials following the shock condition.
Antecedent basis: Substitute spec. ¶¶ [0020], [0054]-[0055], [0059] (shock-tail and irreversibility). Original spec. ¶¶ [0021a], [0026].

29. (Method—Coherence-Index Calibration—Dependent on claim 27) The method of claim 27, further comprising calibrating a coherence threshold c_th applied to C by (i) a baseline alignment operation collecting at least one thousand nominal triples and selecting c_th such that a Lyapunov-style stability increment ΔV≤0 is satisfied in at least ninety-five percent of observations, (ii) a perturbation-testing operation injecting at most five percent noise into the environment signal or the perception signal and verifying that C falls below c_th before any ΔV>0 condition or unsafe action occurs, and (iii) a replay-testing operation re-running logged historical control cycles and requiring C to match logged values within plus or minus five percent in at least ninety-nine percent of windows.
Antecedent basis: Substitute spec. ¶ [0049] (calibration protocol). Original spec. ¶ [0013] verbatim.

30. (Computer-Readable Medium—Independent) A non-transitory computer-readable medium storing instructions that, when executed by one or more processors, cause the one or more processors to perform, within each of a plurality of discrete control cycles, operations comprising:
(a) constructing a perspective tensor Π comprising a parameterized reasoning-state topology constructed from one or more multimodal inputs to an intelligent inference system;
(b) computing an integrity-flux scalar Iφ=dE/dt+dR/dt−dP/dt at a sample rate of at least ten hertz;
(c) computing a bounded coherence index C∈[0,1] from environment-perception-reality multimodal signal triples;
(d) computing an integrity-linked adaptive contraction bound E(Iφ)=ε₀/(1+κ·|Iφ|), wherein ε(Iφ) is monotonically decreasing in |Iφ|;
(e) enforcing the integrity-linked contraction relation |α−β|≤ε(Iφ);
(f) when the integrity-linked contraction relation is satisfied, applying a parameter update Δθ according to a projected-gradient bounded-update law dθ/dt=μ·[∇_θU(θ)+Γ(Π, α, β)] with U(θ)=λ₁·Iφ+λ₂·C−λ₃·H_X and λ₁+λ₂+λ₃=1, and projecting the parameter update such that ∥Δθ∥≤Δθ_MAX per control window; and
(g) when the integrity-linked contraction relation is not satisfied, deterministically suppressing the parameter update by setting Δθ:=0 and substituting a safe baseline control output u:=u_safe.
